(19) United States
(12) Patent Application Publication
(10) Pub. No.: US 2023/0031211 A1
(43) Pub. Date: Feb. 2, 2023

(54) ULTRAFINE OXYGENATED NANOBUBBLES HYDROTHERAPY

(71) Applicants: Richard C. Applewhite, Houston, TX (US); Jason K. Applewhite, Magnolia, TX (US); David G. Carfagno, Scottsdale, AZ (US); Mayur M. Dev, Phoenix, AZ (US)

(72) Inventors: Richard C. Applewhite, Houston, TX (US); Jason K. Applewhite, Magnolia, TX (US); David G. Carfagno, Scottsdale, AZ (US); Mayur M. Dev, Phoenix, AZ (US)

(21) Appl. No.: 17/699,730

(22) Filed: Mar. 21, 2022

Related U.S. Application Data
(60) Provisional application No. 63/150,935, filed on Feb. 18, 2021.

(51) Int. Cl. A61H 35/00; A61H 33/00; A61H 33/02

(52) U.S. Cl. CPC A61H 35/006; A61H 33/028; A61H 33/0095; A61H 35/00; A61H 2205/06; A61H 2205/10

(57) ABSTRACT

A method for enhancing tissue oxygenation by bathing the body or part of a body in water infused with oxygenated microbubbles.

### CROSS-REFERENCE TO RELATED APPLICATIONS

This application claims priority from the U.S. provisional pat. application serial number 63/150,935, filed on Feb. 18, 2021, which is incorporated herein by reference in its entirety.

### FIELD OF INVENTION

The present invention relates to topical application of oxygen, and more particularly, relates to a method of enhancing tissue oxygenation by exposing epidermis and dermis to ultrafine oxygenated nanobubbles.

### BACKGROUND

Oxygen is essential for life and the body gets oxygen through the respiratory system. The lungs of the respiratory system include specialized cells that can absorb oxygen from the inhaled air. The oxygen is then transported to different tissues in the body through blood. This natural process of air intake is sufficient under normal conditions, however, due to certain medical conditions or increased physical activity, the natural process of oxygen intake may be insufficient and slow to cope up with the increased oxygen demand of the body. Athletes after training generally feel oxygen deficiency and take a good amount of time to recover from the training-induced stress on the body. Increasing the oxygen intake has shown positive results and quicker recovery.

The current method of increasing the oxygen supply to the tissues generally includes increasing the oxygen concertation in the air inhaled. For example, hyperbaric chamber technology is known wherein a person is kept inside a closed pressurized chamber. The oxygen levels inside the chamber can be artificially increased, such as the patient can breathe more oxygen. Although such methods have shown positive body response, the therapeutic effect is minor and often insignificant. A desire is there for an improved method of increasing oxygen perfusion through topical application.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

It is therefore a principal object of the present invention to enhance tissue oxygenation through topical application of oxygen.

It is another object of the present invention that the method is economical in application and practice.

It is still another object of the present invention that method provides for both localized and systemic increase is oxygen saturation.

It is yet another object of the present invention that the method provides a faster rate of tissue oxygenation to the desired levels.

It is a further object of the present invention that the method provides for reducing inflammation and swelling of tissue.

It is still a further object of the present invention that the method hastens recovery from injury or physical activity-induced stress.

It is yet a further object of the present invention that the method provides for improved sleep and energetic feel.

It is an additional object of the present invention that the method provides detoxification of skin and body.

It is still an additional object of the present invention that the method provides for healthier skin.

In one aspect, the present invention is directed to a method for enhancing tissue oxygenation by bathing the body or part of a body in water infused with oxygenated microbubbles.

In one aspect, the size of microbubbles can range from 0.02 -0.1 microns.

These and other objects and advantages of the embodiments herein and the summary will become readily apparent from the following detailed description taken in conjunction with the accompanying drawings

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing water infused with microbubbles generated from a bubble generator, according to an exemplary embodiment of the present invention.

FIG. 2 is a graph showing the results of the hydrotherapy on a test case, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

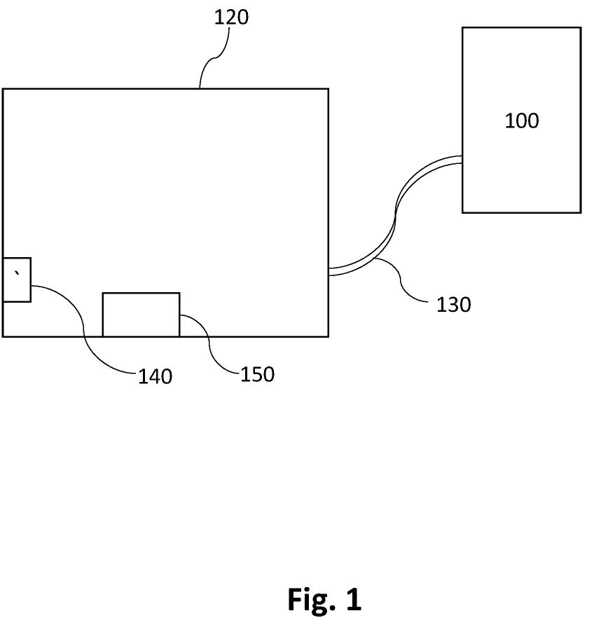

Disclosed is a method for enhancing tissue oxygenation by bathing the body or body part in water infused with oxygenated microbubbles. Referring to FIG. 1 which shows a bubble generator 100 that can generate microbubbles in a size range of about 0.02 microns to 0.1 microns, and preferably in the range of 0.02 microns to 0.01 microns. The bubble generator 100 can be in fluid communication with a tub 120, for example, one or more tubes 130 can connect the output of the bubble generator to the inner volume of the tub. The end of the tube may open at bottom of the tub, and in case of the multiple tubes, multiple spaced inlets can be provided in the tub for connecting to the tubes. The oxygenated water can be pumped into the tub while the water in the tub can be circulated back to the bubble generator for oxygenation. The tub may also include a temperature control unit that can maintain the temperature of water within a predefined temperature range. The structure and functioning of such temperature control unit 140 for maintaining the temperature within preset range are known to a skilled person and any such temperature control units can be used without departing from the scope of the present invention. Additionally, the tub may also include an impeller 150 to create a whirlpool in the water, however, such impellers can be optional.

The body or part of the body, such as legs or arms can be bathed in the water infused with oxygenated microbubbles from the bubble generator. The microbubble-based hydrotherapy can be provided for a sufficient duration determined based on the medical and physical condition of the user.

The microbubble being small in size than the pores of the skin (~50 microns) can penetrate the skin pores enhancing the oxygen perfusion and absorption into bodily tissues, thereby improving tissue health and recovery via reducing inflammation and free radical damage and improving immune modulators and energy status at the cellular level. Possibly, the cells can also be rejuvenated as a result of ultra-fine bubbles. As the ultra-fine bubbles exit the pores, they flush away the impurities, leaving the skin reinvigorated and hydrated. Additionally, the skin’s collagen production can also stimulate as a result of enhanced perfusion in the tissues. Effective oxygen delivery may also increase reactive oxygen species at therapeutic levels to initiate an early cascade of valuable growth factors and neovascularization. This decreases fine wrinkles making the skin smoother and younger-looking. The instant effects of the ultra-fine bubble hydrotherapy bath can be energized feeling with soft skin without the use of soaps or oils.

In one exemplary embodiment, the ultrafine bubbles can be compressed by ions at the gas-liquid interface. The method can provide enhanced water contact with the introduced gas using a variable pitch helical vane which due to its design, creates extremely fine gas bubbles. The created bubbles are so small they are unable to break the surface tension of the water without agitation, minimizing gas off. Thus, the microbubbles are retained in water for a sufficiently long duration increasing the oxygen concentration in water.

The disclosed method was tested in several users for both tissue oxygenation and therapeutic effects. Near-infrared spectroscopy (NIRS) was used to measure regional oxygen saturation of the recovering tissues. NIRS is a non-invasive technology that utilizes multiple lasers and detectors to determine the mixed venous blood oxygen saturation of tissues 1-3 cm below the sensors by measuring the absorption spectra of the tissue chromophores oxyhemoglobin and deoxyhemoglobin. The mixed venous oxygen saturation is affected by many aspects of physiology, but overall represents the relationship of oxygen delivery and utilization in tissues. NIRS sensor in the studies was the Moxy device that records muscle oxygen saturation (SMO2) of the rectus femoris muscle. The other is the Nonin device that records regional oxygen saturation (rSO2) over the femoral vessels.

### Example 1. CD

CD is an active high school track athlete with no chronic medical conditions who has a heavy training regimen in preparation for racing. During his season he trains several days per week with rigorous workouts that focus on sprints. He frequently experiences post-training soreness the day following rigorous training. The severity of his symptoms is comparable to many of his peers with similar training schedules.

On exam, CD is an athletic appearing, well-nourished, pleasant, and cooperative teenage male. He has normal vitals at rest in addition to benign cardiac and pulmonary exams. He exhibits the full range of motion in his extremities and no signs of pain or injury with exercise.

### Methods

CD was consented and eager to participate in this study. CD was evaluated and cleared for participation before the study by a board-certified sports medicine physician. He was continuously monitored during the study by both a board-certified sports medicine physician and a professional sports physiologist.

During the study, CD wore a neoprene sleeve on the right thigh that held the Moxy SMO2 sensor in place over the right rectus femoris. He also wore a heart rate (HR) monitor on the right humerus over the brachial artery. These sensors provided real-time capture and continuous monitoring of SMO2 and HR.

From time 0-5 minutes, CD was at rest in a comfortable seated position. He was then transitioned to a treadmill and began jogging at 5-6 mph and a goal of 75% maximum HR from time 6-15 minutes. CD was then transferred to a bathtub equipped with the microbubble infuser. CD was positioned in a resting position with his bilateral lower extremities and lower trunk submerged, other than the very top of the Moxi sensor which was kept above the surface for data capturing purposes.

The water was maintained at 95° F. CD remained in non-infused water for 20 minutes with an oxygen content of 4 parts per million (ppm), from time 18-38 minutes. The microbubble infusion was started and delivered increased amounts of oxygen to the bathwater. CD remained in this treatment environment for 25 minutes, from time 38-63 minutes. The water oxygen concentration increased from 4 ppm before initiation of oxygenation, up to a peak of 18.9 ppm. After the 25-minute treatment, CD was transferred out of the bath where he stood to dry off and recover. The study period was completed at this time.

### Results

During the initially dry, seated resting period from 0-5 minutes, CD’s baseline SMO2 values ranged from 50-60%. This dropped significantly to a low value of 10% SMO2 during the exercise treatment period, time 6-15 minutes. After transitioning to the 95-degree Fahrenheit bath without disclosed hydrotherapy and an oxygen concentration of 4 ppm for 20 minutes, from time 18-38 minutes, the SMO2 increased to an average near 60%. Upon initiation of microbubble infusion of the treating bathwater, which lasted for a 25-minute treatment from time 38-63 minutes, both the water oxygen concentration and SMO2 increased.

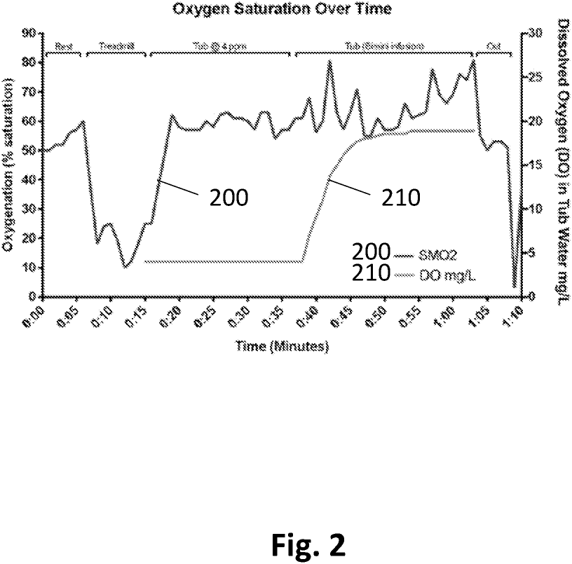

The water oxygenation without microbubble infusion was steady around 4 ppm but progressively increased with the initiation of microbubble infusion to a peak value of 18.9 ppm at time 54 minutes. During the first 15 minutes of the microbubble infusion, SMO2 had peaks and valleys. This included values near CD’s baseline of 50-60% SMO2, with two significant peaks of 81% SMO2 and 71% SMO2 at times 42 minutes and 46 minutes, respectively. For the last 10 minutes of the microbubble infusion, from time 53-63 minutes, the SMO2 values climbed steady, returning to 81% SMO2 once again by the end of the treatment. After the 25-minute microbubble infusion treatment, CD exited the bath where he rested in a standing position while drying off and completing the study. The SMO2 value returned to the 50's % and even lower false values were recorded as the Moxy sensor was manipulated during drying and removed from the patient. FIG. 2 shows the real-time oxygenation values of the right rectus femoris utilizing a SMO2 sensor. Curve 200 is of SMO2 and curve 210 is of Dissolved oxygen. Real-time dissolved oxygenation values of the bathwater used for treatment during the time of microbubble infusion. (Values at time 51-53 minutes were not recorded due to technical difficulties, therefore the value from time 50 was kept in place for these time intervals to maintain the linear congruency of the graph.) CD provided subjective data following this treatment. He performs a weekly intense sprint exercise routine. The previous week he had completed his sprint routine with difficulty, however, the day following the microbubble infusion treatment, CD was able to increase his sprints by 50% without major difficulty.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for hydrotherapy to enhance tissue oxygenation, the method comprising the step of:
bathing a body in water supersaturated with oxygenated microbubbles for a predetermined duration.

2. The method according to claim 1, wherein the method further comprises the step of controlling temperature of the water within a predefined range.

3. The method according to claim 1, wherein the microbubbles are in a size range of about 0.02 to 0.1 microns.

4. The method according to claim 1, wherein the microbubbles are in a size range of about 0.02 to 0.01 microns.

5. A method for hydrotherapy to enhance tissue oxygenation, the method comprising the step of:
bathing a body part in water supersaturated with oxygenated microbubbles for a predetermined duration.

6. The method according to claim 5, wherein the method further comprises the step of controlling temperature of the water within a predefined range.

7. The method according to claim 5, wherein the microbubbles are in a size range of about 0.02 to 0.1 microns.

8. The method according to claim 5, wherein the microbubbles are in a size range of about 0.02 to 0.01 microns.

9. The method according to claim 5, wherein the body part is a leg or foot.

10. The method according to claim 5, wherein the body part is an arm.
